(19) United States
(12) Patent Application Publication
(10) Pub. No.: US 2003/0144951 A1
(43) Pub. Date: Jul. 31, 2003

(54) System and method of managing IP access for user groups

(75) Inventor: Daniel Leven, Rosh Ha-Ayin (IL)

Correspondence Address: SUGHRUE MION, PLLC, 2100 PENNSYLVANIA AVENUE, N.W., WASHINGTON, DC, 20037, US

(73) Assignee: COMVERSE, LTD.

(21) Appl. No.: 10/059,110

(22) Filed: Jan. 31, 2002

(51) Int. Cl. G06F 17/60

(52) U.S. Cl. 705/40

(57) ABSTRACT

A system and method of managing the amount of usage of IP access to services for a user group are provided. The system includes: a user terminal through which a user interacts with the system; a user database for storing a user data; a real-time billing mediator for monitoring and collecting data traffic flowing through the system; a charging server for reading the user data from the user database and sending the user data to the real-time billing mediator; a user group provisioning station for updating the user data; and an application/content server for storing applications/content. The user group, rather than a network operator, provides controlling and provisioning of the IP access of individual users of the user group in the system.

### BACKGROUND OF THE INVENTION

1. Field of the Invention

The present invention relates generally to a system and method for managing the amount of usage of IP (Internet Protocol) access to services for a group of users. More particularly, the system is provided with a real time billing mediator and a user group provisioning station, in which methods for controlling a user's IP access and provisioning of the user's IP access are used to manage the IP access for a user group.

2. Description of the Related Art

While user groups of IP services, such as a corporate user group, desire IP connectivity for their members, many of these user groups require the ability to manage the IP access on an individual basis for each member of the group. For example, in the corporate user group, the members are employees of the corporation, and therefore IP access should be limited to activities related to the employees' work, and therefore the employees should not have unlimited IP access.

A common type of IP access is mobile IP access. Since corporate users are heavy users of mobile IP access, network operators are willing to provide attractive billing packages for the use of the network by corporate users. For example, a network operator may charge a corporate user a certain price for a particular number of gigabytes of data traffic per month generated by the corporate user group. Although the price of the billing package may be attractive, the usefulness of the package is diminished if the corporate user group cannot control the amount of IP traffic generated by individual users in the corporate user group or the destinations, i.e. servers, of this traffic on a per-user basis.

One way of providing management of individual user's IP access is through a COS (Class of Service) feature, which can be provided by the network operator. The COS feature defines the maximum number of bytes per month that the user is allowed. However, the COS feature is cumbersome and costly and places a heavy burden on the network operator's customer service operations, since the network operator must manage the COS for each user.

### SUMMARY OF THE INVENTION

The system and methods of the present invention are applicable to situations in which IP traffic passes through a device which is able to collect data on the traffic in order to bill the user and to check IP access on an individual basis. Such a device is called a Real Time Billing Mediator (RTBM). An example of an RTBM is the Comverse Real Time Data Billing solution (RTDB) manufactured by Comverse, Inc., Wakefield, Mass. 01880. The present invention defines a provisioning interface to the RTBM, which can be used by corporate or other user groups to define the service given to each of its users. During each connection of a user, the RTBM monitors the user access quota, for instance (but not limited to) by maintaining a counter of the number of bytes transferred by the user or maintaining a counter of the number of connections made by the user to a given server within a window of time. The RTBM disconnects the user or notifies the corporate user when the user exceeds his/her allowed usage.

In an illustrative, non-limiting embodiment of the invention, a system for managing IP access for user groups is provided which enables management of IP access by the user groups, thereby eliminating the burden on network operators. The system includes: a user terminal through which a user interacts with the system; a user database for storing user data; a real-time billing mediator for monitoring and collecting data traffic flowing through the system; a charging server for reading the user data from the user database and sending the user data to the real-time billing mediator; a user group provisioning station for updating the user data; and an application/content server for storing applications/content.

In another illustrative, non-limiting embodiment of the invention, a method of controlling a user's IP access is provided, in which a user group controls the IP access of individual users of the user group. The method includes: requesting a connection to an application/content server via a user terminal; requesting user data from a charging server; retrieving the user data from a user database; transmitting the user data to a real-time billing mediator; determining whether a user access is allowed; establishing a connection between the user terminal and the application/content server, if it is determined that the user access is allowed; monitoring the user access, if the connection is established; determining whether the user has exceeded a user access quota; and terminating the connection or notifying the user that the user access is not allowed and terminating the user access, if it is determined that the user access is not allowed or if it is determined that the user has exceeded the user access quota.

In another illustrative, non-limiting embodiment of the invention, a method of provisioning a user's IP access is provided, in which a user group, rather than a network operator, performs the provisioning of the IP access of individual users of the user group. The method includes: logging into a charging server via a user group provisioning station, thereby beginning a provisioning session; inputting a user access quota or the access quota of a number of users belonging to the user group via the user group provisioning station; sending an update request from the user group provisioning station to the charging server; updating the user access quota in a user database; determining whether to terminate the provisioning session; logging out of the charging server via the user group provisioning station, if it is determined to terminate the provisioning session.

The present invention applies not only to corporate user groups, but it also applies to user groups in general, such as the subscribers of an Application Service Provider (ASP).

### BRIEF DESCRIPTION OF THE DRAWINGS

FIG. 1 is a block diagram of one embodiment of a system for managing IP access for a user group;

FIG. 2 shows an embodiment of a method of controlling user IP access via a real-time billing mediator; and

FIG. 3 shows an embodiment of a method of provisioning user IP access via a user group provisioning station.

### DESCRIPTION OF THE ILLUSTRATIVE EMBODIMENTS

The following description of the embodiments discloses specific configurations, features, and operations. However, the embodiments are merely examples of the present invention, and thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations, features, and operations of the present invention that would have been known to one skilled in the art are omitted for the sake of clarity and brevity.

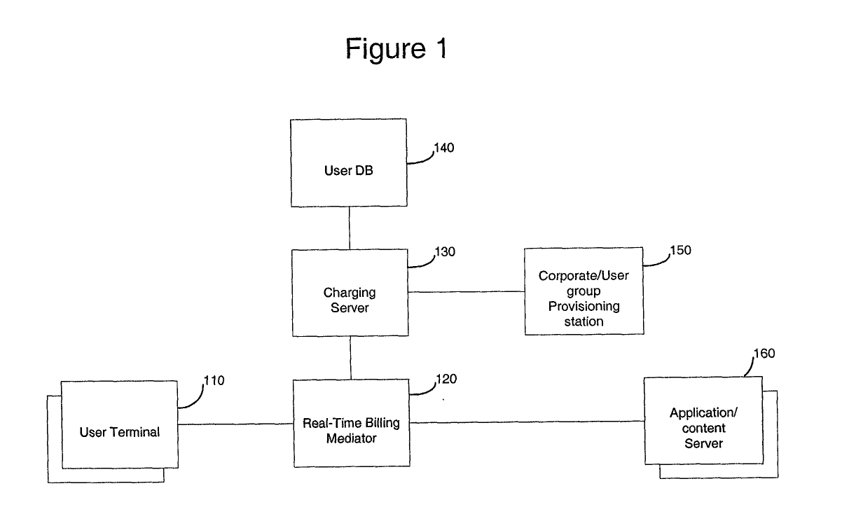

FIG. 1 is a general block diagram of one embodiment of a system for managing IP access for a user group. In FIG. 1, a user terminal 110 is the device through which the user performs interactions with applications/content residing in an application/content server 160. The user terminal 110 and the application/content server 160 are connected through the real-time billing mediator 120. Data traffic passes through the real-time billing mediator 120, which monitors the data traffic and collects data from the data traffic.

The real-time billing mediator 120 receives data corresponding to predetermined limits on the user's IP access from a charging server 130, when the user initiates a connection from the user terminal 110. The user initiates a connection using the network standard IP protocols, telephony signaling protocols etc. The real-time billing mediator 120 receives user identification information (e.g. from the network signaling protocols) from a user terminal 110 and then checks the received user identification information with data received from the charging server 130.

The user's access is interrupted if the user exceeds one or more of the predetermined limits on usage, which are stored in a user database 140. The predetermined limits include, for example, a user access quota, which is a limit on the amount of data that a user can upload or download, a predetermined number of connections to a particular application/content server per time period (forbidding access to a server can be implemented by setting the number of connections to a specific server to zero), and/or a predetermined number of messages (e.g. e-mail, voice mail etc.). The predetermined limits in the user database 140 are updated by a user group system administrator using a user group provisioning station 150 via the charging server 130.

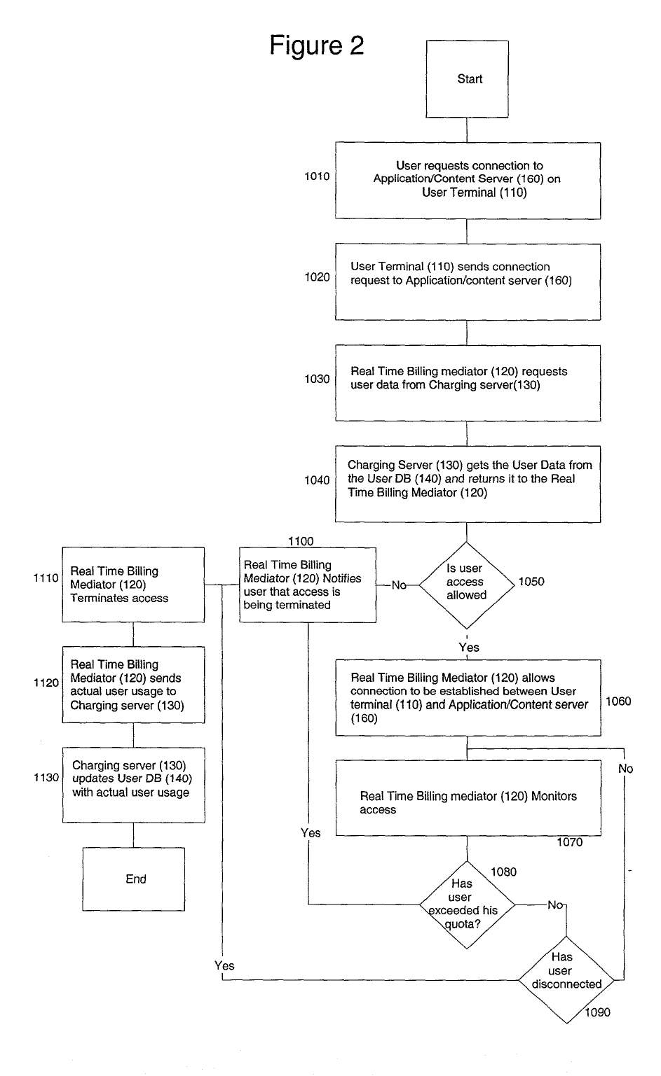

FIG. 2 shows an embodiment of a method of controlling user IP access via a real-time billing mediator. In operation 1010, a user enters user information (e.g. the user's password) and requests a connection to an application/content server 160 via a user terminal 110. The user terminal 110 sends the connection request through the real-time billing mediator 120 to the application/content server 160 in operation 1020.

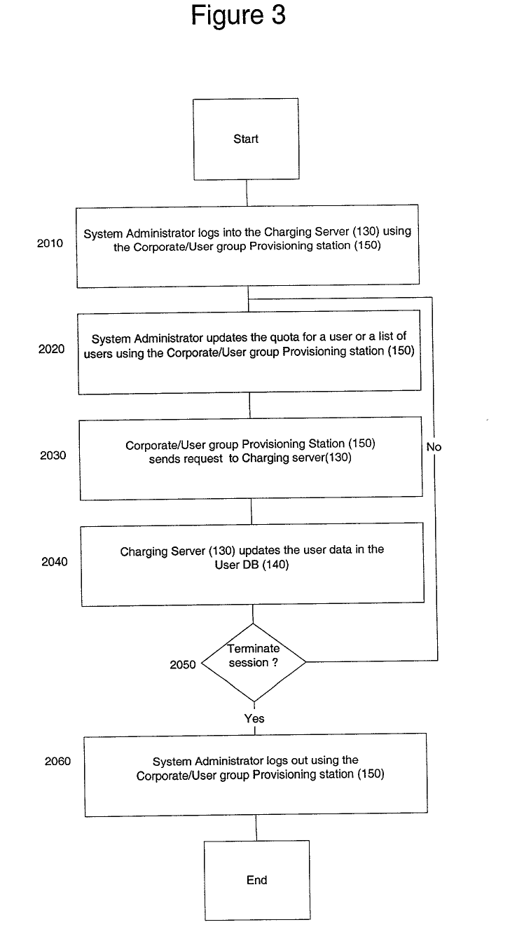

In operation 1030, the real-time billing mediator 120 requests the user data from the charging server 130. The charging server 130 reads the user data from the user database 140, which receives the user data of one user or a range of users simultaneously from the user group provisioning station 150 (discussed below in reference to FIG. 3), and returns the user data to the real-time billing mediator 120 in operation 1040.

The real-time billing mediator 120 determines, in operation 1050, whether user access is allowed. Determining whether user access is allowed is accomplished by (a) counting the actual user usage of specific usage parameters by the real time billing mediator 120 and maintaining it persistently in the user data base 140 between user sessions and, (b) comparing, by the real time billing mediator 120, the actual user usage to the predetermined usage limits, which are stored in the user data base 140, for the user. If user access is allowed, the real-time billing mediator 120 allows a connection to be established between user terminal 110 and an application/content server 160 in operation 1060. The connection is established in a typical manner of making IP connections, which depends on the type of interface required, e.g. TCP/IP, RTP, etc. If the connection is established, the real-time billing mediator 120 monitors the user's access in operation 1070 to keep track of the user's IP usage.

If, in operation 1080, it is determined that the user has exceeded one or more of his predetermined usage limits (e.g. the user access quota), then the real-time billing mediator 120 notifies the user that the user's access is being terminated in operation 1100, and the real-time billing mediator 120 terminates the user's access in operation 1110. Whether the user has exceeded a predetermined limit on IP access usage is determined, as explained above, by a comparison between the total amount of usage allowed and the total amount of usage that has been used.

On the other hand, if it is determined in operation 1080 that the user has not exceeded his IP access quota or other predetermined limit, then the real-time billing mediator 120 checks whether the user has disconnected in operation 1090. If it is determined in operation 1090 that the user has disconnected, then the real time billing mediator 120 terminates the access in operation 1110. After the user's access is terminated, the real-time billing mediator 120 notifies the charging server 130 of the user's usage during the user's most recent connection to the application/content server 160 in operation 1120. Then the charging server 130 updates the user's total access usage in the user database 140 by adding the most recent amount of usage to the previous total of IP access usage of the user in operation 1130.

On the other hand, if it is determined in operation 1090 that the user has not disconnected, then the real time billing mediator 120 continues to monitor the user's access in operation 1070 to keep track of the user's IP usage amount.

If the user access is not allowed in operation 1050, then the real-time billing mediator 120 notifies the user that the user's access is being terminated in operation 1100, and in operation 1110 the real-time billing mediator 120 terminates the user's access.

FIG. 3 shows an embodiment of a method of provisioning user IP access via the user group provisioning station 150, which allows a system administrator to set and/or change predetermined limits on the IP access of one or more users.

When a system administrator logs into the charging server 130 using a user group provisioning station 150 in operation 2010, a user access provisioning session is initiated. In operation 2020, the system administrator inputs one or more predetermined limits on a user's IP access usage (e.g. a user access quota) or the IP access usage of a number of users belonging to the user group on the user group provisioning station 150.

In operation 2030, the user group provisioning station 150 sends an update request to the charging server 130. Then, in operation 2040, the charging server 130 updates the user data in the user database 140. The update is a normal update operation of a database, e.g. for an Oracle database or any other relational database, a Structured Query Language (SQL) command is used to perform the update. The database 140 is a conventional, preferably, but not necessarily, relational database. If additional users with different user access quotas are present, operations 2020-2040 are repeated for each additional user. On the other hand, if all of the additional users have the same user access quota, then the user access quota for each of the users is updated concurrently. Concurrent updating can be performed in more than one way. For example, the user group provisioning station 150 can go through the list of user group users and send a request for each individual user to the charging server 130, which updates the user access quota in the user database 140, or the user group provisioning station 150 can send a request for the update for a range of users or a sub-list of users from the list of user group users to the charging server 130, and the charging server 130 updates the user database 140.

An example of this process follows. The system administrator sends a request to update the access quota of user A, user B, and user C with a quota of 10 Mb/month. The request is sent from the provisioning station 150 to the charging server 130 using an IP protocol (e.g. XML over HTTP). The charging server 130 sends an SQL update command for each of the users (user A, user B, user C) to update their quotas in the database to 10 Mb/month. Alternatively, a single SQL command can be sent to the database to update the quotas of users A, B, and C to 10 Mb/month. Other database updating procedures are within the scope of knowledge of those skilled in the art.

When the system administrator decides to terminate the provisioning session in operation 2050, the system administrator logs out of the charging server using the user group provisioning station 150 in operation 2060.

The operations of FIGS. 2-3 may be implemented by software in the system for managing IP access for a user group via a program stored in, or carried via, a read only memory (“ROM”), a random access memory (“RAM”), a floppy disk, a hard disk, an optical disk, a carrier wave (e.g. a carrier wave transmitted via the internet, a vertical blanking interval of a television signal, etc.), or any other computer readable medium. The software in the system is stored in, and controls the operation of, the user terminal 110, the real time billing mediator 120, the charging server 130, the user database 140, and the provisioning station 150.

Although the preferred embodiments of the present invention have been described, it will be understood by those skilled in the art that the present invention is not limited to the described preferred embodiments, but various changes and modifications can be made within the spirit and scope of the present invention as defined by the appended claims.

What is claimed is:

1. A system for managing IP access of a user in a user group, comprising:
a user terminal through which the user interacts with the system;
a user database for storing user data;
a real-time billing mediator for monitoring and collecting data flowing through the system;
a charging server for reading the user data from the user database and sending the user data to the real-time billing mediator;
a user group provisioning station for updating the user data; and
an application/content server for storing applications/content.

2. The system of claim 1, wherein the user data comprises a user access quota.

3. The system of claim 1, wherein the user group is a corporate user group.

4. The system of claim 1, wherein the user data comprises a predetermined number of connections to the application/content server per time period.

5. The system of claim 1, wherein the user data comprises a predetermined number of messages.

6. A method of controlling IP access of a user in a user group, comprising:
a) requesting a connection to an application/content server via a user terminal;
b) determining whether a user access is allowed, based on a predetermined limit on the user access input by a system administrator of the user group;
c) establishing a connection between the user terminal and the application/content server, if it is determined that the user access is allowed;
d) monitoring the user access, if the connection is established;
e) determining whether the connected user has exceeded the predetermined limit on the user access; and
f) notifying the user that the user access is not allowed and terminating the user access, if it is determined that the user has exceeded the predetermined limit.

7. The method of claim 6, further comprising:
g) requesting a user data from a charging server;
h) retrieving the user data from a user database;
i) transmitting the user data to a real-time billing mediator; and
j) notifying the user that the user access is not allowed and terminating the user access, if it is determined that the user access is not allowed.

8. The method of claim 7, wherein the real-time billing mediator performs the operations c, d, e, and j.

9. The method of claim 7, further comprising:
k) sending an actual user usage data to the charging server; and
l) updating the actual user usage data in a user database.

10. A method of provisioning IP access of a user by a user group, comprising:
a) inputting a predetermined limit on user access or the predetermined limits on the access of a number of users belonging to the user group via a user group provisioning station; and
b) updating a user access quota or the access quotas of a number of users belonging to the user group in a user database, based on the predetermined limit or limits of the inputting operation.

11. The method of claim 10, further comprising:
c) logging into a charging server via the user group provisioning station, thereby beginning a provisioning session;
d) sending an update request from the user group provisioning 5 station to the charging server;
e) determining whether to terminate the provisioning session; and
f) logging out of the charging server via the user group provisioning station, if it is determined to terminate the provisioning session.

12. The method of claim 11, wherein, when each of a plurality of additional users has a different predetermined limit on user access, operations a, b, d, e, and f are repeated for each of the additional users.

13. The method of claim 11, wherein, when each of a plurality of additional users has the same predetermined limit on user access, the predetermined limit of each of the additional users is updated concurrently.

14. The method of claim 11, wherein a system administrator performs the operations b, c, e, and f.

15. Software contained in a computer readable medium, wherein said software comprises instructions to instruct a processor for performing operations, comprising:
a) requesting a connection to an application/content server via a user terminal;
b) determining whether a user access is allowed, based on a predetermined limit on the user access input by a system administrator of the user group;
c) establishing a connection between the user terminal and the application/content server, if it is determined that the user access is allowed;
d) monitoring the user access, if the connection is established;
e) determining whether the connected user has exceeded the predetermined limit on the user access; and
f) notifying the user that the user access is not allowed and terminating the user access, if it is determined that the user has exceeded the predetermined limit.

16. The software of claim 15, further comprising:
g) requesting a user data from a charging server;
h) retrieving the user data from a user database;
i) transmitting the user data to a real-time billing mediator; and
j) notifying the user that the user access is not allowed and terminating the user access, if it is determined that the user access is not allowed.

17. The software of claim 16, further comprising:
k) sending an actual user usage data to the charging server; and
l) updating the actual user usage data in a user database.

18. A system for managing IP access between a user terminal, through which a user in a user group interacts with the system to obtain IP access, and an application/content server, comprising:
a user database for storing a user data;
a real-time billing mediator for monitoring and collecting data flowing through the system; and
a charging server for reading the user data from the user database and sending the user data to the real-time billing mediator.

19. The system of claim 18, further comprising a user group provisioning station for updating the user data.
